(19) United States
(12) Patent Application Publication
(10) Pub. No.: US 2009/0053579 A1
(43) Pub. Date: Feb. 26, 2009

(54) NOVEL POWER SUPPLY DEVICE AND ELECTRONIC APPARATUS INCLUDING THE SAME

(75) Inventor: Yuichi Tokita, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/188,041

(22) Filed: Aug. 7, 2008

(30) Foreign Application Priority Data
Aug. 20, 2007 (JP) 2007-213582

(51) Int. Cl. H01M 2/02; H01M 4/00

(52) U.S. Cl. 429/34; 429/22

(57) ABSTRACT

A power supply device is provided and includes a fuel introduction unit from which a fuel edible, drinkable, and safe to contact for human body is introduced. The power supply device also includes a fuel cell unit including a negative electrode that is exposed to outside through the fuel introduction unit and that can contact with the fuel, the fuel cell unit being configured to generate electrical energy from the fuel; and an electronic controller unit configured to control feeding of the electrical energy to an external device.

### CROSS REFERENCES TO RELATED APPLICATIONS

The present application claims priority to Japanese Patent Application JP 2007-213582 filed in the Japanese Patent Office on Aug. 20, 2007, the entire contents of which is incorporated herein by reference.

### BACKGROUND

Electronic apparatuses operate on electricity supplied from primary batteries such as dry cells, secondary batteries such as car batteries and lithium ion batteries, and general power sources such as household wall plugs. A primary battery is a battery that contains a reactive substance inside and generates an electrical current by the chemical reaction of the reactive substance. A primary battery can be used until all reactive substance is consumed. A secondary battery also contains a reactive substance inside and the amount of reactive substance decreases as the electricity is generated. However, the secondary battery can be reused since a reverse reaction occurs by charging and the reaction products thereby return to the original reactive substance.

A general power source such as a household wall plug is rarely used as a power source of mobile electronic appliance. Furthermore, a general power source is not available at the time of blackout such as in the event of disasters. In contrast, primary and secondary batteries are convenient to carry along and can be used in the times when power supply is stopped. However, they have a limited capacity for supplying power and may not be able to supply sufficient power to advanced electronic apparatuses. Although secondary batteries can be reused by charging, they need external power for charging. Thus, secondary batteries after all electricity is discharged are not usable in the event of blackout as with the general power sources.

In recent years, development of fuel cells that can keep generating power as long as a fuel and air are supplied has progressed. A fuel cell generates power several to several ten times larger than the power generated by an existing battery per unit fuel volume or weight and is thus suitable for size reduction. Moreover, a fuel cell produces less wastes and is clean, and is thus attracting much attention amid environmental concerns that exist today.

For example, Japanese Unexamined Patent Application Publication No. 2005-332687 describes a fuel cell system that achieves size and weight reduction, the system being configured to feed a fuel to a fuel cell unit by deforming a fuel container and to thereby necessitate no battery for fuel feeding.

Japanese Unexamined Patent Application Publication No. 2004-71262 describes a direct methanol fuel cell that has a fuel cartridge containing an aqueous methanol solution as the fuel and generates power as the fuel is fed from the cartridge.

Japanese Unexamined Patent Application Publication No. 2007-66756 describes a fuel cartridge having a pressure releasing valve that controls the fuel jetting direction to a direction perpendicular to the direction in which the fuel cell is inserted so that jetting of the fuel from the electronic apparatus is prevented. A fuel cell including the cartridge and an electronic apparatus including the cartridge are also described.

In these fuel cells, a gas such as hydrogen, methane, ethane, or propane, or a liquid such as methanol has been used as the fuel. However, these fuels have adverse effects on human body and are inflammable. For example, methanol, which is frequently used in fuel cells, is highly toxic to human body, and methanol once absorbed in the human body during handling or the like is may lead to loss of eyesight or, at worst, death. Moreover, since methanol is highly volatile, there is explosion hazard during storage and use.

Furthermore, electronic apparatuses including the fuel cells described above frequently suffer from leakage caused by deterioration of the fuel cell, explosion caused by misoperation, and fire spread. Not only the performance of the battery is desired to be increased but also high safety of the battery is strongly desired.

### SUMMARY

The present disclosure generally relates to power supply devices. In particular, it relates to a power supply device that can supply electricity by appropriately supplying a fuel harmless to human body to the power supply device, and to an electronic apparatus including the power supply device.

According to one embodiment, a power supply device includes a fuel introduction unit from which a fuel edible, drinkable, and safe to contact for human body is introduced. The power supply device also includes a fuel cell unit including a negative electrode that is exposed to outside through the fuel introduction unit and that can contact with the fuel, the fuel cell unit being configured to generate electrical energy from the fuel, and an electronic controller unit configured to control feeding of the electrical energy to an external device.

The type of fuel is not particularly limited as long as it is edible, drinkable, and safe to contact for human body. For example, the fuel is a beverage.

The method for introducing the fuel to the fuel introduction unit is not particularly limited. For example, one of the principles selected from pressure injection, negative pressure injection, contact absorption, and capillary action may be employed.

Another embodiment provides an electronic apparatus including the power supply device described above, and an expression unit that automatically undergoes a physical change recognizable from outside.

The expression unit can automatically undergo various physical changes. For example, physical changes such as movements, sound output, and optical output can be automatically expressed.

The power supply device offers high safety since a fuel edible, drinkable, and safe to contact for human body is used, and the fuel can be supplied at a desired place according to need. Thus, power can be supplied regardless of location.

Additional features and advantages are described herein, and will be apparent from the following Detailed Description and the figures.

### BRIEF DESCRIPTION OF THE FIGURES

FIG. 1 is a schematic diagram showing a basic structure of a power supply device 1;

FIG. 2 is a drawing showing a power supply device 1a in which a fuel introduction unit 2 is formed of a sponge;

FIGS. 3A and 3B are diagrams showing one embodiment of an electronic apparatus;

FIG. 4 is a diagram showing a doll-type electronic apparatus 6b, which is an embodiment different from that shown in FIGS. 3A and 3B;

FIG. 5 is a diagram showing a cap-type electronic apparatus 6c, which is an embodiment different from those shown in FIGS. 3A to 4;

FIG. 6 is a diagram showing an expression unit 7c1 of the cap-type electronic apparatus 6c;

FIG. 7 is a diagram showing an expression unit 7c2 different from that of the cap-type electronic apparatus 6c shown in FIG. 6;

FIG. 8 is a diagram showing a cap-type electronic apparatus 6d having a built-in digital audio player as en expression unit for outputting sound;

FIG. 9 is a diagram showing an insect-type electronic apparatus 6e, which is an embodiment different from those shown in FIGS. 3A to 8;

FIG. 10 is a schematic diagram showing how the fuel is supplied to the insect-type electronic apparatus 6e;

FIG. 11 is a diagram showing a fish-type electronic apparatus 6f, which is an embodiment different from those shown in FIGS. 3A to 10;

FIG. 12 is a schematic diagram showing the internal structure of the fish-type electronic apparatus 6f;

FIG. 13 is a diagram showing a ship-type electronic apparatus 6g, which is an embodiment different from those shown in FIGS. 3A to 12; and

FIG. 14 is a diagram showing an electronic apparatus 6h, which is an embodiment different from those shown in FIGS. 3A to 13.

### DETAILED DESCRIPTION

Embodiments will now be described with reference to the attached drawings. The embodiments described below are merely examples of representative embodiments and do not limit the scope of the present application.

### <Power Supply Device>

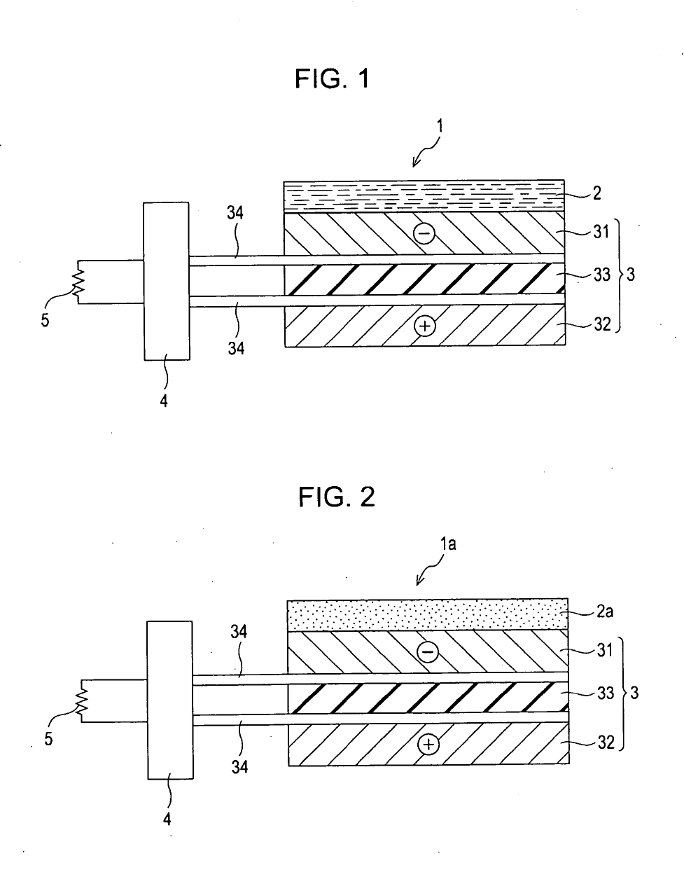

FIG. 1 is a schematic diagram showing a basic structure of a power supply device 1. The power supply device 1 can be roughly divided to a fuel introduction unit 2, a fuel cell unit 3, and an electronic controller unit 4. A resistor 5 shown in FIG. 1 interconnects the power supply device 1 to a power receiving apparatus such as an electronic appliance.

### 1. Fuel Introduction Unit 2

The type and form of the fuel introduction unit 2 are not particularly limited as long as a fuel necessary for power generation can be introduced to the power supply device 1. For example, any of the principles of pressure injection, negative pressure injection, contact absorption, and capillary action can be employed. FIG. 2 shows an example of a contact absorption type, which is a power supply device 1a having a fuel introduction unit 2 made of a sponge.

A fuel that is edible, drinkable, and safe to contact for human body is fed to the fuel introduction unit 2. Any material that is edible, drinkable, and safe to contact for human body can be used as long as the material can serve as the fuel for the fuel cell. Examples of the material include beverages such as juice, sport drink, sugared water, and alcohols, and cosmetic products such as lotions. In other words, beverages, cosmetic products, and the like that people take in everyday life can be used as the fuel for the power supply device 1. In particular, those materials containing sugars, proteins, fatty acids, and the like are preferred since they release electrical energy in the course of decomposition.

### 2. Fuel Cell Unit 3

The fuel cell unit 3 has a negative electrode 31 and a positive electrode 32 facing each other with a separator 33 for blocking the passage of electrons therebetween. A charge collector 34 is disposed between each electrode (negative electrode 31 and the positive electrode 32) and the separator 33. The charge collectors 34 interconnects the fuel cell unit 3 and the electronic controller unit 4 described below. In the fuel cell unit 3, electrical energy is generated by a series of reactions: electrons released by oxidation reaction of the fuel at the negative electrode 31 migrate to the positive electrode 32 through via charge collectors 34, and the reduction reaction occurs between the electrons and oxygen supplied from outside at the positive electrode 32.

The negative electrode 31 of the fuel cell unit 3 is exposed to the exterior through the fuel introduction unit 2. It has been a common technical understanding that the electrodes (negative electrode 31 and positive electrode 32) of the power supply apparatus should remain unexposed to the exterior from the safety viewpoint. However, this perception is greatly changed and a structure that exposes the negative electrode 31 to the exterior is employed in the power supply device 1 so that the desired amount of fuel can be supplied to the cell any time. In this power supply device 1, a fuel edible, drinkable, and safe to contact for human body is used so that the desired amount of fuel can be supplied at any timing and that safety is ensured in the event of fuel leakage.

Any material that can be electrically connected to an external device can be used as the material of the negative electrode 31 without any limitation. Examples of the material include metals such as Pt, Ag, Au, Ru, Rh, Os, Nb, Mo, In, Ir, Zn, Mn, Fe, Co, Ti, V, Cr, Pd, Re, Ta, W, Zr, Ge, and Hf; alloys such as alumel, brass, duralumin, bronze, nickelin, platinum-rhodium, hyperco, permalloy, permendur, nickel silver, and phosphor bronze; conductive polymers such as polyacetylenes; carbon materials such as graphite and carbon black; borides such as HfB₂, NbB, CrB₂, and B₄C; nitrides such as TiN and ZrN; silicides such as VSi₂, NbSi₂, MoSi₂, and TaSi₂; and composite materials of these.

If necessary, an enzyme may be immobilized on the negative electrode 31. In the case where a beverage containing a sugar is used as the fuel, an oxidase that oxidatively decomposes the sugar may be immobilized. Examples thereof include glucose dehydrogenase, gluconate 5-dehydrogenase, gluconate 2-dehydrogenase, alcohol dehydrogenase, aldehyde reductase, aldehyde dehydrogenase, lactate dehydrogenase, hydroxypyruvate reductase, glycerate dehydrogenase, formate dehydrogenase, fructose dehydrogenase, and galactose dehydrogenase.

In addition to the oxidase described above, an oxidized coenzyme and a coenzyme oxidase may be immobilized on the negative electrode 31. Examples of the oxidized coenzyme include nicotinamide adenine dinucleotide (referred to as “NAD⁺” hereinafter), nicotinamide adenine dinucleotide phosphate (referred to as “NADP⁺” hereinafter), flavin adenine dinucleotide (referred to as “FAD⁺” hereinafter), and pyrroloquinoline quinone (referred to as “pQQ²⁺” hereinafter). An example of the coenzyme oxidase is diaphorase.

As the oxidative decomposition of the fuel occurs at the negative electrode 31, oxidation-reduction reactions are repeated in which the oxidized coenzymes described above are respectively reduced to NADH, NADPH, FADH, and PQQH², and the resulting reduced coenzymes return to the oxidized coenzymes by the coenzyme oxidases. When the reduced coenzymes return to oxidized coenzymes, two electrons are generated.

Moreover, in addition to the oxidases and the oxidized coenzymes described above, an electronic mediator may be immobilized on the negative electrode 31. This is to enhance smoothness of migration of the electrons between the electrodes. Examples of the electronic mediator include 2-amino-3-carboxy-1,4-naphthoquinone (ACNQ), vitamin K3, 2-amino-1,4-naphthoquinone (ANQ), 2-amino-3-methyl-1,4-naphthoquinone (AMNQ), 2,3-diamino-1,4-naphthoquinone, metal complex of osmium (Os), ruthenium (Ru), iron (Fe), cobalt (Co), and the like, viologen compounds such as benzyl viologen, compounds having quinone skeletons, compounds having nicotinamide structures, compounds having riboflavin structures, and compounds having nucleotide-phosphoric acid structures.

Various materials currently available may be used as the material for the positive electrode 32. Any material electrically connectable to an external device may be used as the positive electrode 32 material without limitation. Examples thereof include metals such as Pt, Ag, Au, Ru, Rh, Os, Nb, Mo, In, Ir, Zn, Mn, Fe, Co, Ti, V, Cr, Pd, Re, Ta, W, Zr, Ge, and Hf; alloys such as alumel, brass, duralumin, bronze, nickelin, platinum-rhodium, hyperco, permalloy, pennendur, nickel silver, and phosphor bronze; conductive polymers such as polyacetylenes; carbon materials such as graphite and carbon black; borides such as HfB₂, NbB, CrB₂, and B₄C; nitrides such as TiN and ZrN; silicides such as VSi₂, NbSi₂, MoSi₂, and TaSi₂; and composite materials of these.

At the positive electrode 32, reduction reaction between the electrons fed through the charge collectors 34 from the negative electrode 31 and oxygen fed from outside occurs. Thus, it is desirable that the positive electrode 32 be designed so that it can receive oxygen from outside. Although the positive electrode 32 can be formed to come into contact with air, in the case of using the power supply device 1 in a solution that can serve as a fuel, oxygen can be fed to the positive electrode 32 by rendering the surface of the positive electrode 32 water repellent.

### 3. Electronic Controller Unit 4

The electronic controller unit 4 controls feeding of electrical energy in feeding the electrical energy generated in the fuel cell unit 3 to an external device. In particular, the voltage of the electrical energy generated in the fuel cell unit 3 is adjusted to a voltage suitable for the specification of the external device (electronic appliance or the like) which receives the electrical energy.

The power supply device 1 may have any size or shape as long as the electrical energy can be supplied. For example, the power supply device 1 may be rectangular parallel piped, cubic, cylindrical, letter-L shaped, or letter-U shaped, or have any combination of these shapes. The power supply device 1 may be provided alone or as a combination of a plurality of power supply devices. In using a plurality of power supply devices 1, they may be connected in series, parallel, or both.

### <Electronic Apparatus>

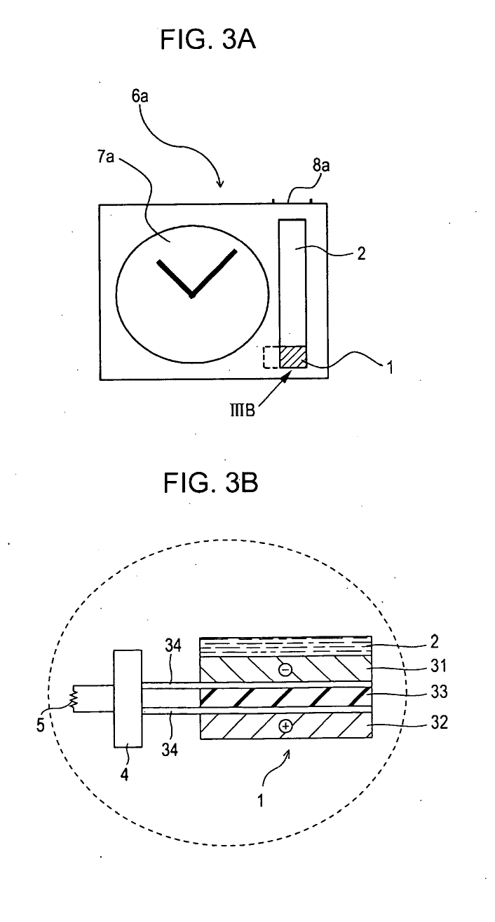

The power supply device 1 is suitable for use in an electronic apparatus. FIG. 3A is a diagram showing an embodiment of an electronic apparatus 6a. The electronic apparatus 6a can be roughly divided into the power supply device 1 and an expression unit 7a. The expression unit 7a automatically undergoes physical changes recognizable from outside as the electrical power is supplied from the power supply device 1. In the example shown in FIGS. 3A and 3B, the physical changes are movements of a clock.

The arrangement and size of the power supply device 1 of the electronic apparatus 6a are not particularly limited as long as electrical power can be supplied to the expression unit 7a. In the electronic apparatus 6a shown in FIG. 3A, the power supply device 1 is provided at the right-hand side of the expression unit 7a. FIG. 3b is an enlarged cross-sectional view of a part of the power supply device 1.

The electronic apparatus 6a of this embodiment is designed so that the fuel introduction unit 2 of the power supply device 1 is visually recognizable from outside. Moreover, a fuel introduction port 8a is provided above the fuel introduction unit 2. The negative electrode 31 of the power supply device 1 is designed to be exposed to the exterior through the fuel introduction unit 2 and the fuel introduction port 8a.

The electronic apparatus 6a can be operated by feeding from the fuel introduction port 8a a fuel edible, drinkable, and safe to contact for human body. Any material edible, drinkable, and safe to contact for human body can be used as long as the material can serve as the fuel for the fuel cell. Examples of the material include beverages such as juice, sport drink, sugared water, and alcohols, and cosmetic products such as lotions. In other words, beverages, cosmetic products, and the like that people take in everyday life can be used as the fuel for the electronic apparatus 6a. Thus, a desired fuel can be supplied at a desired place.

According to an electronic apparatus of the related art using a general power source such as a household wall plug, the apparatus does not operate at the time of blackout such as in the event of disasters. In the case of an electronic apparatus that uses a battery according to the related art, the electronic apparatus does not work once the battery is exhausted unless the battery is replaced or charged. However, the electronic apparatus 6a of this embodiment can use, as the fuel, a beverage or a cosmetic product that people use in everyday life. Thus, in the event of disasters or when a user is away from his/her houses, the electronic apparatus 6a can be operated as long as the beverage or the like is available.

The following effects are also achieved by forming the fuel introduction unit 2 to be visually recognizable from outside as in the electronic apparatus 6a of this embodiment. According to a battery of the related art, it has been difficult to check the remaining fuel level. Although an electronic apparatus incorporating a battery has been available in which the remaining battery level is roughly indicated in the digital display unit or the like, there has not been an apparatus that enables confirmation of a specific remaining fuel level. However, if the fuel introduction unit 2 is made visually recognizable from outside as with the electronic apparatus 6a, the fuel can be supplied according to the remaining fuel level. Moreover, since the movement of the fuel itself is also recognizable, visual artistic effects are achieved and can be enhanced by changing the color of the fuel or the like.

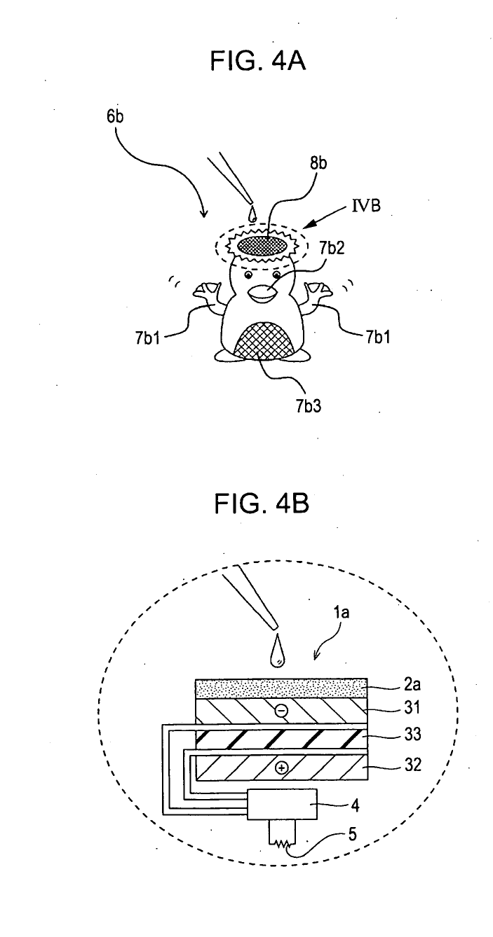

FIG. 4A shows a doll-type electronic apparatus 6b which is an embodiment different from that shown in FIG. 3A. The power supply device 1a (refer to FIG. 4B) is built inside the head (marked by a circle in a broken line) of the doll-type electronic apparatus 6b.

A fuel introduction unit 2a of the power supply device 1a is formed of a sponge so that the fuel can be introduced by contact absorption.

As shown in FIG. 4A, the built-in power supply device 1a generates electrical energy as an appropriate fuel is fed from the fuel introduction port 8b. Expression units (7b1 to 7b3) then automatically undergo physical changes by using the electrical energy. In this example, the expression units of the doll-type electronic apparatus 6b are designed as hands 7b1 and a mouth 7b3 so that the hands 7b1 and the mouth 7b3 express movements. A radio is installed inside a belly 7b3 of the doll as an expression unit for outputting sound.

The doll-type electronic apparatus 6b of this embodiment can be operated by using an everyday beverage or cosmetic product as a fuel. Thus, a user feels as if he/she is feeding a real pet. Therefore, the electronic apparatus of this embodiment also achieves an effect that the action of supplying a fuel is entertaining in itself.

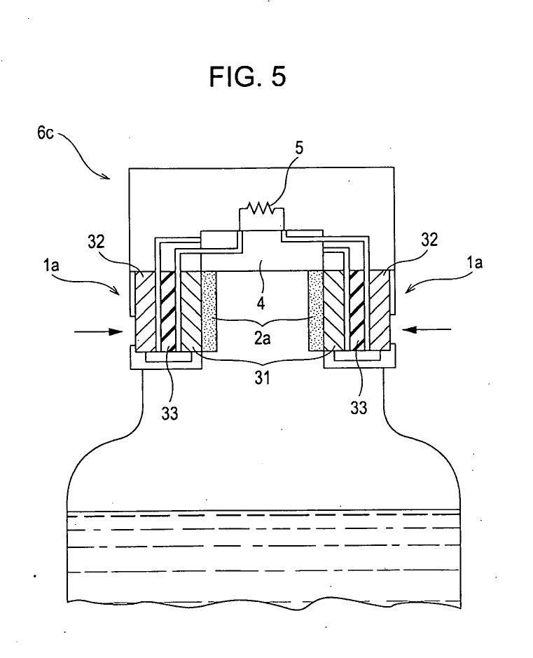

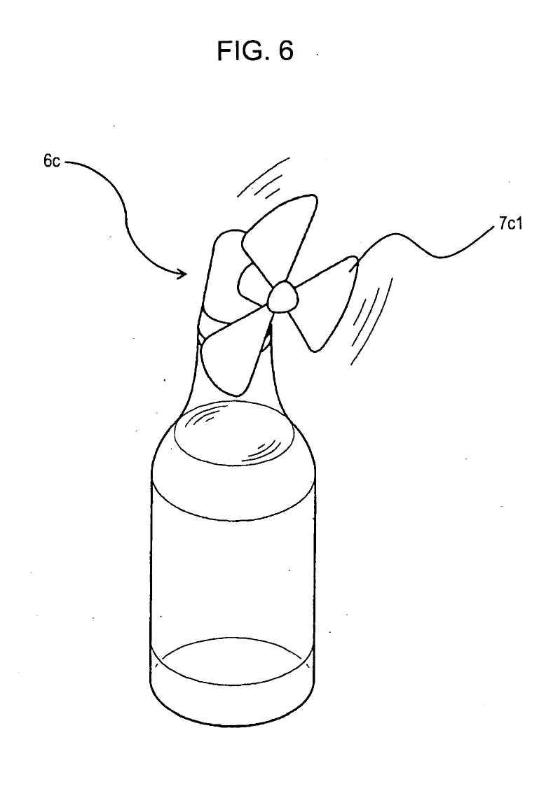

FIG. 5 is a diagram showing a cap-type electronic apparatus 6c, which is an embodiment different from those shown in FIGS. 3A to 4B. The cap-type electronic apparatus 6c of this embodiment has the power supply device 1a built inside the cap of a beverage container.

The fuel introduction port 2a of the power supply device 1a is formed of a sponge so that the fuel can be fed by contact absorption. Two power supply devices 1a are connected in series inside the cap-type electronic apparatus 6c. The number of the power supply devices 1a is not limited to 2, and may be 1 or 3 or more. It is possible to interconnect the power supply devices 1a in parallel instead of in series. It is preferable to form an air port outside the positive electrode 32 at a position indicated by arrows in FIG. 5. This is because oxygen is needed for the reaction at the positive electrode 32.

As the fuel is fed to the fuel introduction port 2a formed of a sponge by tilting or shaking a filled beverage container with the cap-type electronic apparatus 6c, the power supply devices 1a inside generate electrical energy. The expression unit described below then automatically undergoes physical changes by using the electrical energy. Examples of the expression unit are shown in FIGS. 6 to 8.

FIG. 6 shows a propeller 7c1 that functions as an expression unit that undergoes movements. The cap-type electronic apparatus 6c of this embodiment is designed so that the propeller 7c1 can rotate by using the electrical energy generated by the built-in power supply devices 1a.

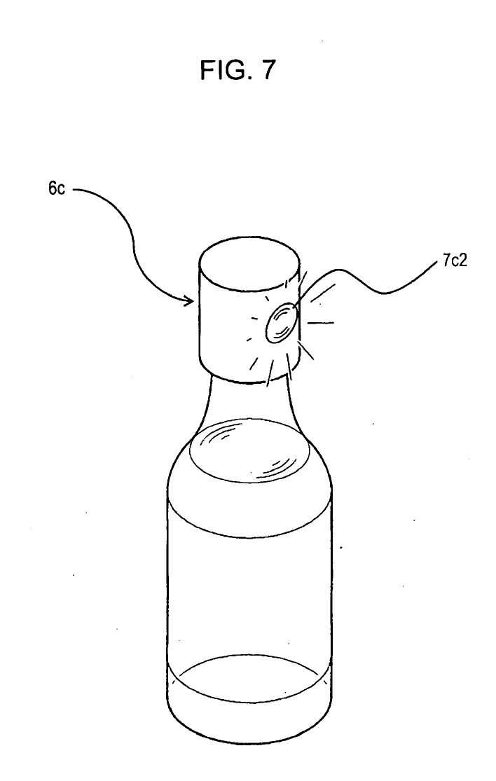

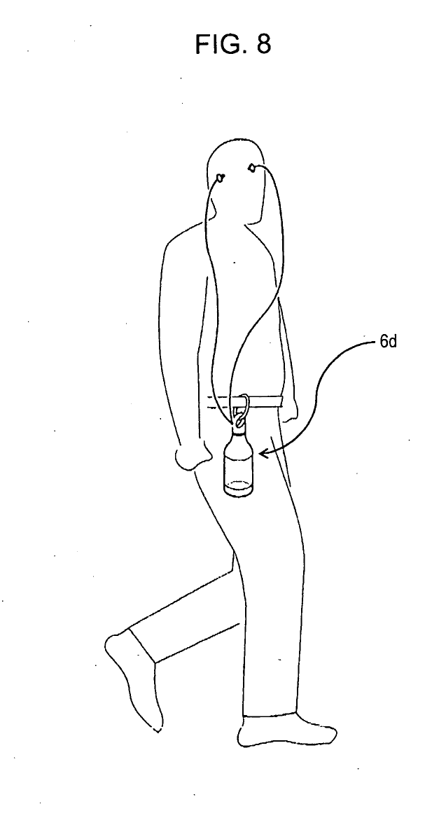

FIG. 7 shows an LED lamp 7c2 that functions as an expression unit that produces optical output. The cap-type electronic apparatus 6c of this embodiment is designed so that the LED lamp 7c2 can emit light by using the electrical energy generated by the built-in power supply devices 1a.

FIG. 8 is a diagram showing a cap-type electronic apparatus 6d with a built-in digital music player as an expression unit that outputs sound. The cap-type electronic apparatus 6d of this embodiment is designed so that the digital music player operates on the electrical energy generated by the built-in power supply devices 1a.

The cap-type electronic apparatuses 6c and 6d described above can also be used as mobile power supply systems (referred to as “cap-type power supply system” hereinafter) if a unit for outputting electrical power to an external device is provided. For example, if the apparatus is designed to be connectable to a cellular phone or a portable music player, power can be supplied to the cellular phone or portable music player from the cap-type power supply system mounted on the beverage container in the event of battery exhaustion.

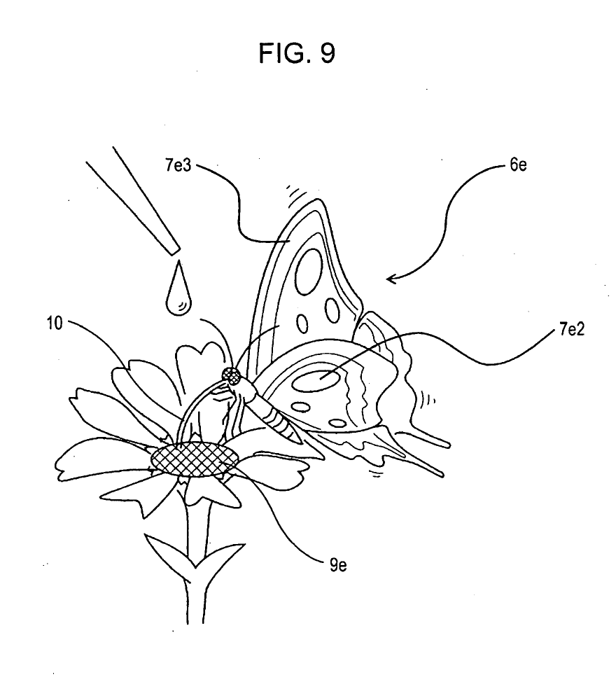

FIG. 9 is a diagram showing an insect-type electronic apparatus 6e which is an embodiment different from those show in FIGS. 3A to 8. The insect-type electronic apparatus 6e is connected to a fuel storage unit 9e through a narrow tube 10. The insect-type electronic apparatus 6e has the power supply device 1 built inside.

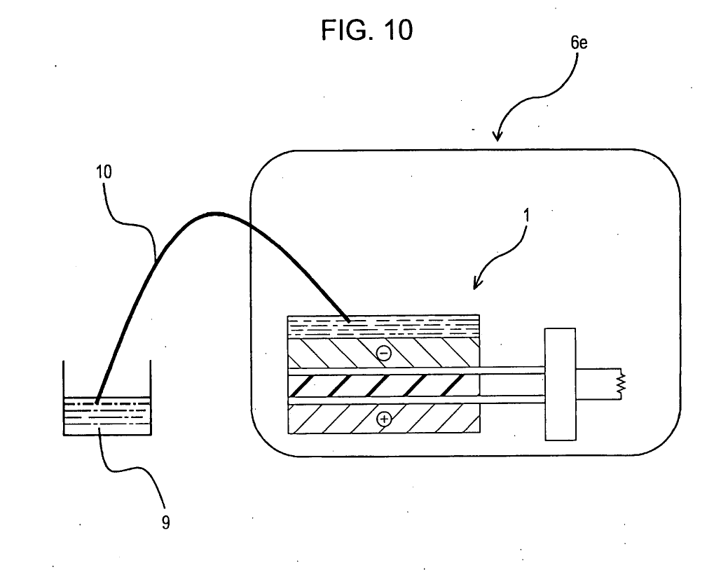

As shown in FIG. 9, an appropriate fuel is fed to the fuel storage unit 9e and is fed to the power supply device 1 through the narrow tube 10 by capillary action (refer to FIG. 10). As the fuel is fed, the built-in power supply device 1 generates electrical energy. The expression units (7e1 and 7e2) then automatically undergo physical changes by using the electrical energy. The expression units of the insect-type electronic apparatus 6e of this embodiment are designed to exhibit movements of flapping of wings 7e1. An LED lamp 7e2 is provided in the wing 7e1 as the expression unit for optical output so that the LED lamp 7e2 emits light by using the electrical energy.

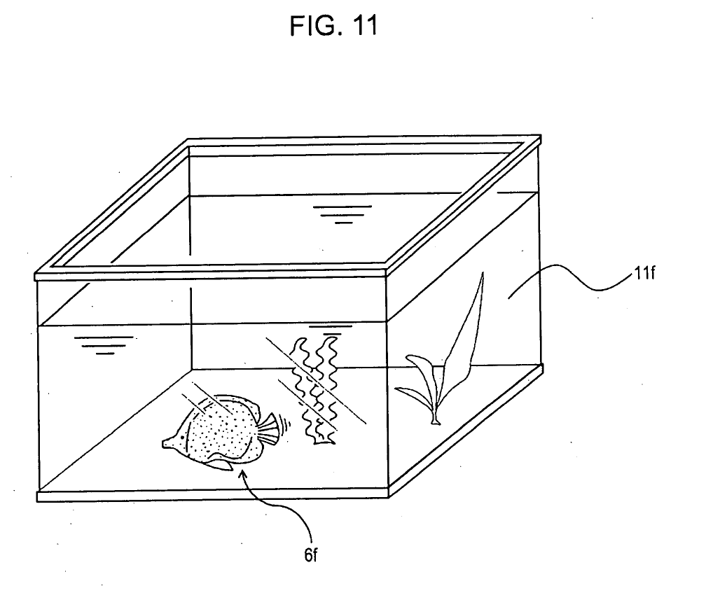

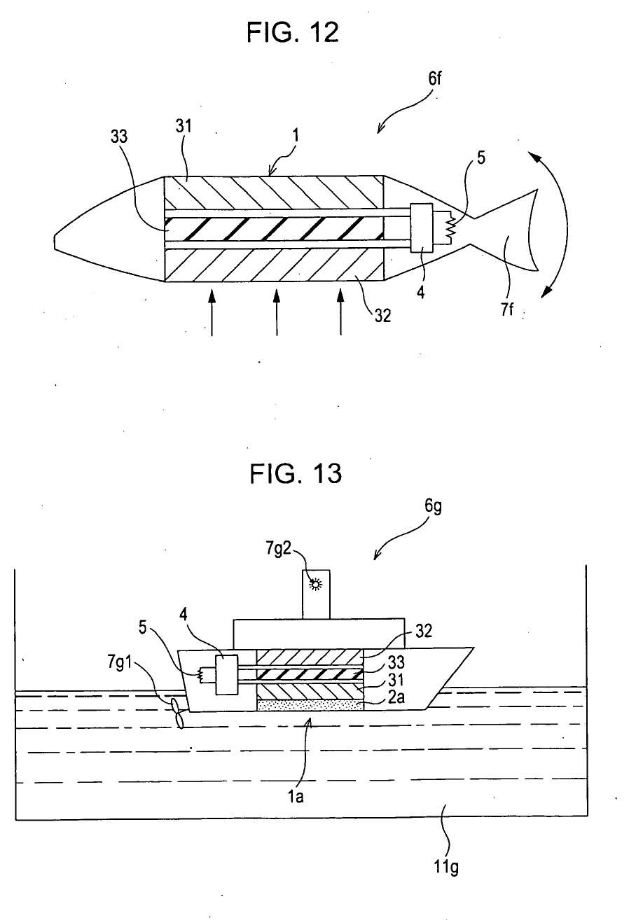

FIG. 11 is a diagram showing a fish-type electronic apparatus 6f, which is an embodiment different from those shown in FIGS. 3A to 10. The fish-type electronic apparatus 6f operates in an aquarium 11f filled with an appropriate fuel. The operation principle will be described in detail with reference to FIG. 12.

FIG. 12 is a schematic diagram showing the internal structure of the fish-type electronic apparatus 6f. The fish-type electronic apparatus 6f of this embodiment has the negative electrode 31 and the positive electrode 32 of the power supply device 1 exposed at the surface of the fish body. This can be realized by, for example, forming the skin of the fish with a meshed material.

As the fish-type electronic apparatus 6f is placed inside the aquarium 1 if filled with the fuel (see FIG. 11), the negative electrode 31 comes into contact with the fuel and the power supply device 1 generates electrical power. An expression unit 7f then automatically undergo physical changes by using the electrical energy. The expression unit of the fish-type electronic apparatus 6f is designed as a fin 7f so that the fish-type electronic apparatus 6f can swim by the movements of the fin 7f.

The power supply device 1 of the fish-type electronic apparatus 6f of this embodiment has no fuel introduction unit 2 since the aquarium 11f itself serves as the fuel introduction unit 2. Alternatively, the power supply device 1 may be provided with a fuel introduction unit 2 formed of a sponge or the like.

FIG. 13 is a diagram showing a ship-type electronic apparatus 6g, which is an embodiment different from those shown in FIGS. 3A to 12. The ship-type electronic apparatus 6g of this embodiment operates in a vessel 11g filled with an appropriate fuel.

The ship-type electronic apparatus 6g of this embodiment has the power supply device 1a inside in which the fuel introduction port 2a formed of a sponge, the negative electrode 31, the separator 33, and the positive electrode 32 are stacked in that order from the ship bottom.

As the ship-type electronic apparatus 6g floats on the fuel filling the vessel 11g, the fuel is fed from the fuel introduction port 2a according to the principle of contact absorption and comes into contact with the negative electrode 31. The power supply device 1 then generates electrical energy. The expression units (7g1 and 7g2) then automatically undergo physical changes by using the electrical energy. The expression units of the ship-type electronic apparatus 6g of this embodiment are designed as a screw 7g1 so that the ship-type electronic apparatus 6g can move and as an LED lamp 7g2 for producing optical output so that light can be emitted by the electrical energy.

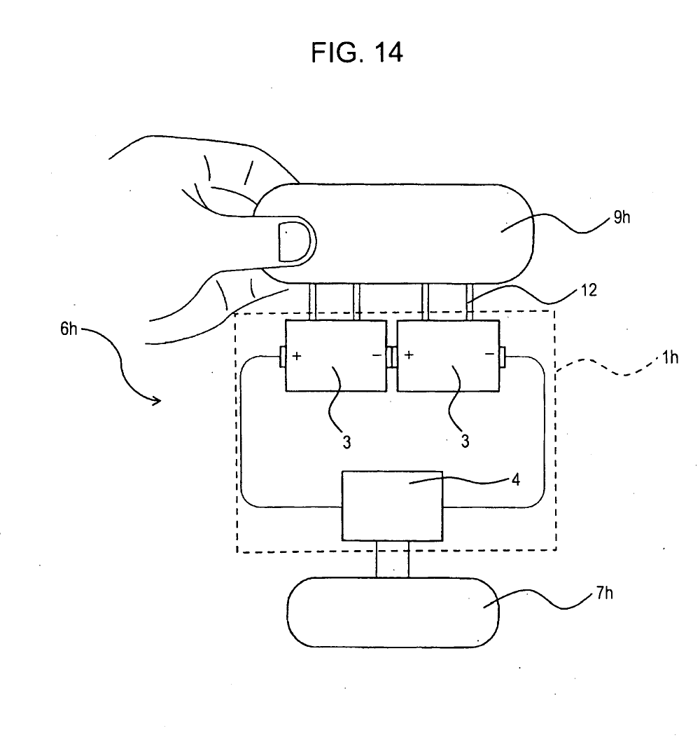

FIG. 14 is a diagram showing an electronic apparatus 6h, which is an embodiment different from those shown in FIGS. 3A to 13. The electronic apparatus 6h of this embodiment is roughly divided into a fuel storing unit 9h, a power supply device 1h, and an expression unit 7h. The power supply device 1h has a fuel introduction port (not shown), and the fuel storing unit 9h communicates with the fuel introduction port through a fuel injection pipe 12.

As shown in FIG. 14, as the fuel storing unit 9h is pressed, the fuel filling the fuel storing unit 9h is introduced into the fuel introduction port of the power supply device 1h through the fuel injection pipe 12. The power supply device 1 then generates electrical energy, and the energy is supplied to the expression unit 7h.

The expression unit 7h of the electronic apparatus 6h is not particularly limited in terms of structure, function, and the like as long as it can automatically undergo physical changes recognizable from outside by using the power supplied from the power supply device 1h. Examples thereof include portable music players, portable digital music players, cellular phones, personal computers, and gaming apparatuses.

In the electronic apparatus 6h of this embodiment, the fuel storing unit 9h, the power supply device 1h, and the expression unit 7h can be disassembled and used independently. For example, it is possible to detach the fuel storing unit 9h in normal times to facilitate carrying and to connect the fuel storing unit 9h to the power supply device 1h to generate electrical energy only when the power is needed. Moreover, the power supply device 1h can be arranged to be connectable to various electronic apparatuses so that the power supply device 1h can be carried along while having the expression unit 7h detached therefrom and that the power supply device 1h can be used as the portable power supply for various electronic apparatuses as needed.

The power supply devices described above are highly safe since a fuel edible, drinkable, and safe to contact for human body is used. Thus, there is no need to provide a rigid fuel leakage-preventing structure as with existing batteries. Moreover, a high-level technology is not needed for the production and the cost and time can be saved.

Because an everyday beverage or cosmetic product can be used as the fuel, the fuel can be supplied at any desired place according to need. Thus, the device can be used as the power source when power supply is stopped such as in the event of disasters.

Because a safe fuel is used in the power supply device, the structure can be freely designed without considering fuel leakage and the like. Thus, an electronic apparatus incorporating the power supply device can be rendered entertaining quality and/or a visual aesthetic effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A power supply device comprising:
a fuel introduction unit from which a fuel edible, drinkable, and safe to contact a human body is introduced;
a fuel cell unit including a negative electrode that is exposed to outside through the fuel introduction unit and that can contact with the fuel, the fuel cell unit being configured to generate electrical energy from the fuel; and
an electronic controller unit configured to control feeding of the electrical energy to an external device.

2. The power supply device according to claim 1, wherein the fuel is a beverage.

3. The power supply device according to claim 1, wherein the fuel introduction unit employs one of the principles selected from pressure injection, negative pressure injection, contact absorption, and capillary action.

4. An electronic apparatus comprising:
a power supply device including
a fuel introduction unit from which a fuel edible, drinkable, and safe to contact a human body is introduced,
a fuel cell unit including a negative electrode that is exposed to outside through the fuel introduction unit and that can contact with the fuel, the fuel cell unit being configured to generate electrical energy from the fuel, and
an electronic controller unit configured to control feeding of the electrical energy to an external device; and
an expression unit that automatically undergoes a physical change recognizable from outside.

5. The electronic apparatus according to claim 4, wherein the physical change is at least one selected from movements, sound output, and optical output.
